(19) United States
(12) Patent Application Publication
(10) Pub. No.: US 2025/0343235 A1
(43) Pub. Date: Nov. 6, 2025

(54) NEGATIVE ELECTRODES FOR RECHARGEABLE LITHIUM BATTERIES, AND RECHARGEABLE LITHIUM BATTERIES INCLUDING SAME

(71) Applicant: SAMSUNG SDI CO., LTD., Gyeonggi-do (KR)

(72) Inventor: Inhwan KO, Gyeonggi-do (KR)

(73) Assignee: SAMSUNG SDI CO., LTD., Gyeonggi-do (KR)

(21) Appl. No.: 18/913,218

(22) Filed: Oct. 11, 2024

(30) Foreign Application Priority Data
May 3, 2024 (KR) 10-2024-0059305

(51) Int. Cl. H01M 4/583; H01M 4/02; H01M 4/04; H01M 4/36; H01M 4/38; H01M 4/62

(52) U.S. Cl. CPC H01M 4/583; H01M 4/0404; H01M 4/366; H01M 4/386; H01M 4/621; H01M 2004/027; H01M 2220/30

(57) ABSTRACT

Disclosed are a negative electrode for a rechargeable lithium battery, and a rechargeable lithium battery including the negative electrode. The negative electrode includes a negative electrode current collector, a negative electrode active material layer on the negative electrode current collector, and a protective layer on the negative electrode active material layer and including LiNO₃ and a binder.

### CROSS-REFERENCE TO RELATED APPLICATION

This application claims the benefit of priority to Korean Patent Application No. 10-2024-0059305 filed in the Korean Intellectual Property Office on May 3, 2024, the entire contents of which are incorporated herein by reference.

### BACKGROUND

### 1. Field

Negative electrodes for rechargeable lithium batteries, and rechargeable lithium batteries including the negative electrodes are disclosed.

### 2. Description of the Related Art

With the increased spread of electronic devices that use batteries, such as, e.g., mobile phones, laptop computers, electric vehicles, and the like, the demand for rechargeable batteries with high energy density and high capacity is increasing.

Rechargeable lithium batteries typically include a positive electrode and a negative electrode including an active material capable of intercalating and deintercalating lithium ions, and an electrolyte solution, and the rechargeable lithium batteries generate electrical energy through oxidation and reduction reactions when lithium ions are intercalated and deintercalated from the positive electrode and the negative electrode.

However, while the rechargeable lithium batteries are charged, lithium crystal nuclei may form on the negative electrode surface, and lithium dendrites may grow around the lithium crystal nuclei. Such lithium dendrites are considered as a main cause of reducing the lifecycle and safety of the rechargeable lithium batteries.

### SUMMARY

Some example embodiments include a negative electrode for a rechargeable lithium battery in which the growth of lithium dendrites is reduced or suppressed.

Some example embodiments include a rechargeable lithium battery including the negative electrode.

Some example embodiments include a negative electrode for a rechargeable lithium battery including a negative electrode current collector, a negative electrode active material layer on the negative electrode current collector, and a protective layer located on the negative electrode active material layer and including LiNO₃.

Some example embodiments include a rechargeable lithium battery including the negative electrode according to the above-described example embodiment; a positive electrode, and a separator between the negative electrode and the positive electrode.

In the negative electrode according to some example embodiments, a stable solid electrolyte interphase (SEI) film is formed by LiNO₃, thereby reducing or suppressing the growth of lithium dendrites and improving the lifecycle of a rechargeable lithium battery.

### BRIEF DESCRIPTION OF THE DRAWINGS

FIGS. 1 to 4 are schematic views showing rechargeable lithium batteries according to some example embodiments.

### DETAILED DESCRIPTION

Hereinafter, example embodiments will be described in detail. However, these embodiments are examples, the present disclosure is not limited thereto, and the present disclosure is defined by the scope of claims.

As used herein, when a specific definition is not otherwise provided, it will be understood that when an element such as a layer, film, region, or substrate is referred to as being “on” another element, it can be directly on the other element or intervening elements may also be present.

As used herein, when a specific definition is not otherwise provided, the singular may also include the plural. In addition, unless otherwise specified, “A or B” may mean “including A, including B, or including A and B.”

As used herein, “combination thereof” may mean a mixture, a stack, a composite, a copolymer, an alloy, a blend, and a reaction product of constituents.

As used herein, when a definition is not otherwise provided, a particle diameter may be an average particle diameter. The particle diameter means an average particle diameter (D50), which is a diameter of particles with a cumulative volume of 50 volume % in the particle size distribution. The average particle diameter (D50) may be measured by a method well known to those skilled in the art, for example, by a particle size analyzer, or by a transmission electron microscope image, or a scanning electron microscope image. Alternatively, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, for example, the particles to be measured are dispersed in a dispersion medium and subsequently introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device can be calculated.

In this specification, “(meth)acrylic” means both acrylic and methacrylic. When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Negative Electrode

Some example embodiments include a negative electrode for a rechargeable lithium battery including a negative electrode current collector; a negative electrode active material layer on the negative electrode current collector, and a protective layer located on the negative electrode active material layer and including LiNO₃.

### LINO₃

LiNO₃ is insoluble, or sparingly soluble, in a non-aqueous organic solvent and has desired or improved ion conductivity, but also may react with the non-aqueous organic solvent to form a stable SEI (solid electrolyte interphase) film on the negative electrode surface.

Accordingly, a protective layer including LiNO₃ is formed in a negative electrode, which may be applied to rechargeable lithium batteries to improve a lifecycle at room temperature and a high temperature, compared with a case of applying a negative electrode in which the protective layer is not formed.

There are several types of rechargeable lithium batteries: rechargeable lithium batteries that use a negative electrode having a protective layer that includes LiCl instead of LiNO₃ and may exhibit an improved lifecycle, rechargeable lithium batteries that use a negative electrode without a protective layer and that have a deteriorated lifecycle, and rechargeable lithium batteries that use a negative electrode having a protective layer that includes LiNO₃. When LiNO₃ is used as a protective layer rather than when LiCl is used, a more stable SEI film is formed.

The protective layer may be formed by further including a binder and by using LiNO₃ alone.

In general, a binder may play a role in adhering particles to each other, and in adhering the particles to a negative electrode active material layer.

However, when LiNO₃ is present, the binder may be agglomerated, and when the binder is a polymer material, the binder may act as a resistance to electrodes.

However, even though the protective layer is formed by using LiNO₃ alone, LiNO₃ may from a stable SEI film on the negative electrode surface at the first cycle of the rechargeable lithium battery.

Accordingly, in manufacturing the negative electrode according to some example embodiments, the protective layer may be desirably formed by using LiNO₃ alone without using the binder. For example, the method of forming the protective layer by using LiNO₃ alone may be or include spraying, vapor deposition, and the like.

Furthermore, a lifecycle of the rechargeable lithium batteries may be controlled depending on an amount of LiNO3.

For example, LiNO₃ may be included in an amount of about 0.01 parts by weight to about 10 parts by weight, or about 0.1 parts by weight to about 5 parts by weight, based on 100 parts by weight of a total amount of the negative electrode active material layer.

In addition, LiNO₃ may be included in an amount of about 5 wt % to about 100 wt %, about 20 wt % to about 99 wt %, or about 50 wt % to about 95 wt % based on a total amount of the protective layer.

Within any of the above ranges, as the amount of LiNO₃ is increased, the more stable SEI (solid electrolyte interphase) film may be formed by LiNO₃.

### Binder

In examples, the protective layer may further include a binder. The binder may include at least one of polyvinylalcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but is not limited thereto.

For example, when the binder is included in the protective layer, the binder may be included in an amount of about 0 wt % to about 20 wt %, about 0 wt % to about 2 wt %, or about 0.1 wt % to about 1 wt % (however, it exceeds 0 wt %) based on a total amount of the protective layer.

Within any of the above ranges, the binder substantially evenly coats the LiNO₃ salt and, when adding inorganic particles, the binder adheres the inorganic particles and the negative electrode active material layer and additionally, can substantially evenly coat and attach LiNO₃ and inorganic particles to the surface of the negative electrode active material layer.

### Inorganic Particles

The protective layer may further include inorganic particles.

Generally known rechargeable lithium batteries use a polyolefin-based substrate as a separator to reduce or prevent a short circuit between positive and negative electrodes. However, the polyolefin-based substrate has the disadvantage of having a weak heat resistance.

When the inorganic particles are coated on the surface of the negative electrode active material layer, because a SEI film may be more stable by including a Li—Me—O bond, which results in effectively reducing or suppressing a side reaction. In addition, the corresponding SEI film has high ion conductivity, contributing to improving performance of rechargeable lithium batteries.

Furthermore, because the inorganic particles have desired or improved heat resistance, a protective layer further including the inorganic particles may complement heat resistance of the polyolefin-based substrate.

The inorganic particles may be or include at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The average particle diameter (D50) of the inorganic particles may be about 10 nm to about 3,000 nm, about 100 nm to about 2000 nm, or about 300 nm to about 1,500 nm.

The inorganic particles may be included in an amount of about 5 wt % to about 70 wt %, about 10 wt % to about 50 wt %, or about 15 wt % to about 30 wt % based on the total amount of the protective layer.

Within any of the above ranges, an SEI film with desired or improved ion conductivity is formed on the surface of the negative electrode active material layer to increase a lifecycle of the negative electrode and complement heat resistance of the polyolefin-based substrate.

### Negative Electrode Active Material

The negative electrode active material includes a material capable of reversibly intercalating/deintercalating lithium ions, a lithium metal, an alloy of lithium metal, a material capable of doping and dedoping lithium, or a transition metal oxide.

The material capable of reversibly intercalating/deintercalating the lithium ions is a carbon-based negative electrode active material, and may include, for example, crystalline carbon, amorphous carbon, or a combination thereof. The crystalline carbon may be irregular, or plate, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may be or include silicon, a silicon-carbon composite, SiOₓ (0<x≤2), a Si—Q alloy (wherein Q includes at least one of an alkali metal, an alkaline-earth metal, a Group 13element, a Group 14 element excepting Si, a Group 15 element, a Group 16 element, a transition metal, a rare earth element, and a combination thereof). The Sn-based negative electrode active material may be or include at least one of Sn, SnO₂, a Sn-based alloy, or a combination thereof.

The silicon-carbon composite may be or include a composite of silicon and amorphous carbon. According to some example embodiments, the silicon-carbon composite may include silicon particles and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

The Si-based negative electrode active material or Sn-based negative electrode active material may be mixed with a carbon-based negative electrode active material.

### Negative Electrode

The negative electrode for a rechargeable lithium battery includes a current collector and a negative electrode active material layer on the current collector. The negative electrode active material layer includes a negative electrode active material, and may further include a binder and/or a conductive material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder is configured to adhere the negative electrode active material particles to each other, and helps the negative electrode active material to adhere to the current collector. The binder may be or include a non-aqueous binder, an aqueous binder, a dry binder, or a combination thereof.

The non-aqueous binder may be or include at least one of polyvinylchloride, carboxylated polyvinylchloride, polyvinylfluoride, ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethyleneoxide, polyvinylpyrrolidone, polyepichlorohydrine, polyphosphazene, poly (meth)acrylonitrile, an ethylene propylene diene copolymer, polyvinylpyridine, chlorosulfonated polyethylene, latex, a polyester resin, (meth)acrylic resin, a phenol resin, an epoxy resin, polyvinyl alcohol, and a combination thereof.

When the aqueous binder is the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, and Li.

The dry binder may be or include a polymer material capable of being fibrous, and may be or include, for example, at least one of polytetrafluoroethylene, polyvinylidene fluoride, polyvinylidene fluoride-hexafluoropropylene copolymer, polyethylene oxide, or a combination thereof.

The conductive material is configured to impart conductivity to the electrode, and any electrically conductive material may be a conductive material unless the conductive material causes a chemical change in the battery. Examples of the conductive material may include a carbon-based material such as or including at least one of natural graphite, artificial graphite, carbon black, acetylene black, ketjen black, carbon fiber, carbon nanofibers, carbon nanotubes, and the like; a metal-based material including at least one of copper, nickel, aluminum, silver, etc., in the form of metal powders or metal fibers; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof.

### Rechargeable Lithium Battery

Some example embodiments include a rechargeable lithium battery including the negative electrode according to the above-described example embodiments; a positive electrode; and a separator between the negative electrode and the positive electrode.

Because the rechargeable lithium battery according to some example embodiments includes the negative electrode according to the above-described example embodiments, the lifecycle may be improved.

Hereinafter, a rechargeable lithium battery according to some example embodiments will be described in detail, excluding redundant descriptions of the negative electrode.

### Positive Electrode Active Material

The positive electrode active material may be or include a compound (lithiated intercalation compound) capable of intercalating and deintercalating lithium. For example, one or more types of composite oxides of lithium and a metal including at least one of cobalt, manganese, nickel, and combinations thereof may be used.

The composite oxide may be or include a lithium transition metal composite oxide, and examples may include at least one of a lithium nickel-based oxide, a lithium cobalt-based oxide, a lithium manganese-based oxide, a lithium iron phosphate-based compound, a cobalt-free lithium nickel-manganese-based oxide, or a combination thereof.

As an example, a compound represented by any of the following chemical formulas may constitute the composite oxide. LiₐA_{1-b}X_{b}O_{2-c}D_{c} (0.90≤a≤1.8, O≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤α≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may be or include a high nickel-based positive electrode active material having a nickel content greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material can realize high capacity and can be applied to a high-capacity, high-density rechargeable lithium battery.

### Positive Electrode

The positive electrode for a rechargeable lithium battery may include a current collector and a positive electrode active material layer on the current collector. The positive electrode active material layer may include a positive electrode active material, and may further include a binder and/or a conductive material.

For example, the positive electrode may further include an additive that can constitute a sacrificial positive electrode.

An amount of the positive electrode active material may be about 90 wt % to about 99.5 wt %, and the amount of each of the binder and the conductive material may be about 0.5 wt % to about 5 wt % based on 100 wt % of the positive electrode active material layer.

The binder is configured to attach the positive electrode active material particles to each other, and to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material may be configured to impart conductivity (e.g., electrical conductivity) to the electrode. Any material that does not cause chemical change (e.g., does not cause an undesirable chemical change in the rechargeable lithium battery) and that conducts electrons may be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material including at least one of copper, nickel, aluminum, silver, etc., in a form of a metal powder or a metal fiber; a conductive polymer such as a polyphenylene derivative; or a mixture thereof.

The current collector may include Al, but is not limited thereto.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include a carbonate-based, ester-based, ether-based, ketone-based, alcohol-based solvent, aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone. The alcohol-based solvent may include at least one of ethyl alcohol, isopropyl alcohol, and the like, and the aprotic solvent may include at least one of nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, and the like.

The non-aqueous organic solvent may be used alone or in combination of two or more solvents.

Additionally, when using a carbonate-based solvent, cyclic carbonate and chain carbonate can be mixed, and cyclic carbonate and chain carbonate may be mixed at a volume ratio of about 1:1 to about 1:9.

In an example, the lithium salt dissolved in the organic solvent supplies lithium ions in a battery, enables a basic operation of a rechargeable lithium battery, and improves transportation of the lithium ions between positive and negative electrodes. Examples of a lithium salt may include one, or more than one, of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato)borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be or include a polymer film formed of or including any one of a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, TEFLON (tetrafluoroethylene), and polytetrafluoroethylene.

The organic material may include a polyvinylidene fluoride-based polymer or a (meth)acrylic polymer.

The inorganic material may include inorganic particles including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked on top of one another.

### Rechargeable Lithium Battery

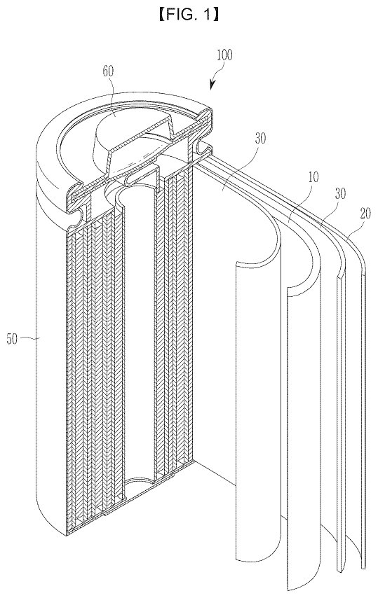

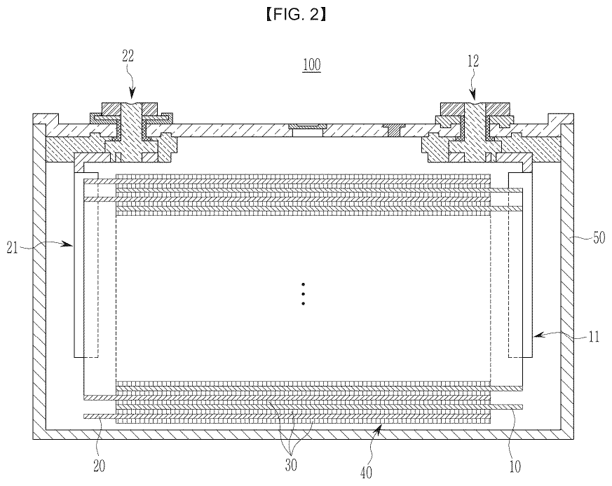

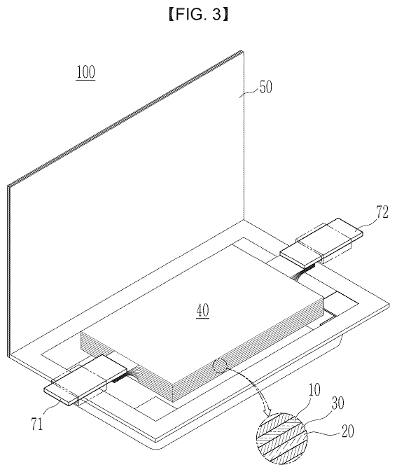

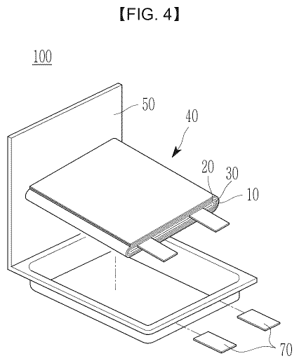

The rechargeable lithium battery may be classified into cylindrical, prismatic, pouch, or coin-type batteries, and the like depending on their shape. FIGS. 1 to 4 are schematic views illustrating a rechargeable lithium battery according to an example embodiment. FIG. 1 shows a circular battery, FIG. 2 shows a prismatic battery, and FIGS. 3 and 4 show pouch-type batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 sealing the case 50, as shown in FIG. 1. In addition, in FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 includes an electrode tab 70 as illustrated in FIG. 4, that is, a positive electrode tab 71 and a negative electrode tab 72 as illustrated in FIG. 3 and forming an electrical path for inducing the current formed in the electrode assembly 40 to the outside.

The rechargeable lithium battery according to some example embodiments may be applicable for use in automobiles, mobile phones, and/or various types of electrical devices, but the present disclosure is not limited thereto.

Hereinafter, examples of the present disclosure and comparative examples are described. These examples, however, are not in any sense to be interpreted as limiting the scope of the disclosure.

### Example 1

### (1) Manufacturing of Negative Electrode

A negative electrode active material was prepared by mixing a graphite material obtained by blending artificial graphite and natural graphite in a ratio of 5:5 with 14.8% of an Si—C composite, and 97.5 wt % of the negative electrode active material, 1.0 wt % of carboxylmethyl cellulose (CMC), and 1.5 wt % of a styrene butadiene rubber (SBR) were mixed in water as a solvent to prepare a negative electrode active material slurry. The negative electrode active material slurry was coated on a copper current collector, and subsequently dried and compressed to form a negative electrode active material layer.

The Si—C composite had a core including artificial graphite and silicon particles and a carbide of coal-based pitch coated on the core surface.

Subsequently, 0.5 parts by weight of LiNO₃ based on 100 parts by weight of the composition was spray-coated on the negative electrode active material layer, and subsequently dried to form a protective layer.

In a finally obtained negative electrode, the negative electrode active material layer had a thickness of 85 μm, and the protective layer had a thickness of ˜1 μm.

### (2) Manufacturing of Positive Electrode

A positive electrode active material slurry was prepared by mixing 97.2 wt % of LiNi_{1※y}AlₓCo_{y}O₂, 0.5 wt % of carbon nanotube, and 1.1 wt % of polyvinylidene fluoride in an N-methyl pyrrolidone solvent. The positive electrode active material slurry was coated on an Al current collector, and subsequently dried and compressed to manufacture a positive electrode.

### (3) Manufacturing of Rechargeable Lithium Battery Cell

The positive electrode and the negative electrode were assembled with a 10 μm-thick polyethylene separator to obtain an electrode assembly, and an electrolyte solution was injected to manufacture a rechargeable lithium battery cell.

The electrolyte solution was prepared by mixing ethylene carbonate, ethylmethyl carbonate, and dimethyl carbonate in a volume ratio of 30:40:40, and dissolving 1.15 M LiPF₆ in the mixed solvent.

### Example 2

A negative electrode and a rechargeable lithium battery cell were manufactured in the same manner as in Example 1 with a difference regarding the method of forming the protective layer.

For example, the protective layer was formed by spray-coating and drying 1 part by weight of LiNO₃ based on 100 parts by weight of the composition of Example 1.

### Example 3

A negative electrode and a rechargeable lithium battery cell were manufactured in the same manner as in Example 1 with a difference regarding the method of forming the protective layer.

For example, the protective layer was formed by spray-coating and drying 5 parts by weight of LiNO₃ based on 100 parts by weight of the composition of Example 1.

### Example 4

A negative electrode and a rechargeable lithium battery cell were manufactured in the same manner as in Example 1 with a difference regarding the method of forming the protective layer.

For example, a protective layer composition including 99 wt % of LiNO₃ and 1 wt % of a CMC (carboxymethyl cellulose) binder was prepared. 1 part by weight of the protective layer composition based on 100 parts by weight of the composition of Example 1 was spray-coated and dried to form a protective layer.

### Example 5

A negative electrode and a rechargeable lithium battery cell were manufactured in the same manner as in Example 1 with a difference regarding the method of forming the protective layer.

For example, a protective layer composition including 94 wt % of LiNO₃, 5 wt % of Al₂O₃ inorganic particles (D50: 2 μm), and 1 wt % of a CMC (carboxymethyl cellulose) binder was prepared. 1 part by weight of the protective layer composition based on 100 parts by weight of the composition of Example 1 was spray-coated and dried to form the protective layer.

### Example 6

A negative electrode and a rechargeable lithium battery cell were manufactured in the same manner as in Example 1 with a difference regarding the method of forming the protective layer.

For example, a protective layer composition including 86.5 wt % of LiNO₃, 12.5 wt % of Al₂O₃ inorganic particles (D50: 2 μm), and 1 wt % of a CMC (carboxy methyl cellulose) binder was prepared. 1 part by weight of the protective layer composition based on 100 parts by weight of the composition of Example 1 was spray-coated and dried to form the protective layer.

### Comparative Example 1

A negative electrode and a rechargeable lithium battery cell were manufactured in the same manner as in Example 1 with a difference that the protective layer was not formed.

### Comparative Example 2

A negative electrode and a rechargeable lithium battery cell were manufactured in the same manner as in Example 1 with a difference that a protective layer composition prepared by using 100 wt % of a binder was used.

### Comparative Example 3

A negative electrode and a rechargeable lithium battery cell were manufactured in the same manner as in Example 1 with a difference that the protective layer composition was prepared by using 86.5 wt % of LiCl, 12.5 wt % of Al2O3 (D50: 2000 nm) as inorganic particles, and 1 wt % of CMC as a binder.

### Evaluation Example 1

### Evaluation of Room-temperature Characteristics of Rechargeable Lithium Battery Cell

Each of the rechargeable lithium battery cells of the examples and the comparative examples were 50 cycles charged at 2.0 C (CC/CV, 4.53 V, cut-off at 0.025 C) and discharged at 1.0 C (CC, cut-off at 3 V) at 25° C. to evaluate capacity retention according to Equation 1. The evaluation results are shown in Table 1.

$$[ Equation 1 ]$$

$$Capacity retention rate ( \% ) = 100 * [ Discharge capacity after charging and discharging 50 \text{} times / Discharging capacity after first charging and discharging ]$$

### Evaluation Example 2

### Evaluation of High-Temperature Characteristics of Rechargeable Lithium Battery Cell

Each of the rechargeable lithium battery cells of the examples and the comparative examples were 50 cycles charged at 2.0 C (CC/CV, 4.53 V, cut-off at 0.025 C) and discharged at 1.0 C (CC, cut-off at 3 V) at 45° C. to evaluate capacity retention according to Equation 2. The evaluation results are shown in Table 1 below.

TABLE 1

| | | | | Performance of | |
|---|---|---|---|---|---|
| | Negative electrode | | | rechargeable lithium | |
| | protective layer | | | battery cell | |
| | | Amount in | lithium | Capacity | Capacity |
| | Type | negative | salt: | retention | retention |
| | of | electrode | binder: | rate (%) | rate (%) |
| | lithium | (parts by | inorganic | @ 25° C., | @ 45° C., |
| | salt | weight) | particles | 50 cyc. | 50 cyc. |
| Example 1 | LINO₃ | 0.5 | 100:0:0 | 94.2 | 92.4 |
| Example 2 | LiNO₃ | 1 | 100:0:0 | 95.1 | 93.5 |
| Example 3 | LiNO₃ | 5 | 100:0:0 | 93.4 | 91.5 |
| Example 4 | LiNO₃ | 1 | 99:1:0 | 93.2 | 91.3 |
| Example 5 | LiNO₃ | 1 | 94:0:1:5 | 95.7 | 94.1 |
| Example 6 | LiNO₃ | 1 | 86.5:1:12:5 | 95.9 | 94.5 |
| Comparative | — | — | — | 92.5 | 90.5 |
| Example 1 | | | | | |
| Comparative | — | 0.5 | 0:100:0 | 0 | 0 |
| Example 2 | | | | | |
| Comparative | LiCl | 0.5 | 86.5:1:12.5 | 92.8 | 90.9 |
| Example 3 | | | | | |

In Table 1, “a content in a negative electrode” was expressed by a “part by weight” unit regarding a weight of a protective layer based on 100 parts by weight of a total weight of a negative electrode active material layer. In addition, in each of the protective layers, a weight ratio of lithium salt:binder:inorganic particles is shown in Table 1.

Referring to Table 1, the rechargeable lithium battery cells manufactured by applying a negative electrode in which a protective layer including LiNO₃ was formed (Examples 1 to 6), when compared with the cell manufactured by applying a negative electrode in which no protective layer was formed (Comparative Example 1), exhibited an improved lifecycle, or capacity retention rate, at room temperature and at high temperature.

Herein, LiNO₃ was confirmed to exhibit the advantage of stably forming an SEI film and reducing or suppressing growth of lithium dendrite. Furthermore, the protective layers were formed by using a binder (Examples 4 to 6) or by using LiNO₃ alone (Examples 1 to 3), wherein the lifecycle, or capacity retention rate, of the rechargeable lithium battery cells was controlled depending on an amount of LiNO₃. Furthermore, when the protective layers were formed by adding inorganic particles (Examples 5 and 6), heat resistance was improved, thereby improving a high-temperature lifecycle, or capacity retention rate.

On the other hand, the rechargeable lithium battery cell to which a negative electrode was manufactured by coating a binder alone (Comparative Example 2) had no ion conductivity and was challenging to drive, and the case of applying a negative electrode in which a protective layer including LiCl instead of LiNO₃ was formed (Comparative Example 3) exhibited an improved lifecycle, compared with the lifecycle of Comparative Example 1, but a deteriorated lifecycle compared with the lifecycles of Examples 1 to 6. This may mean that a more stable SEI film was formed when LiNO₃ was used rather than when LiCl was used.

While this disclosure has been described in connection with what is presently considered to be practical example embodiments, it is to be understood that the disclosure is not limited to the disclosed example embodiments, but, on the contrary, is intended to cover various modifications and equivalent arrangements included within the spirit and scope of the appended claims.

Description of Symbols

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A negative electrode for a rechargeable lithium battery, the negative electrode comprising
a negative electrode current collector;
a negative electrode active material layer on the negative electrode current collector; and
a protective layer on the negative electrode active material layer, the protective layer including LiNO₃.

2. The negative electrode as claimed in claim 1, wherein the LiNO₃ is included in an amount of about 5 wt % to about 100 wt % based on a total amount of the protective layer.

3. The negative electrode as claimed in claim 1, wherein LiNO₃ is included in an amount of about 0.01 parts by weight to about 10 parts by weight based on 100 parts by weight of a total amount of the negative electrode active material layer.

4. The negative electrode as claimed in claim 1, wherein the protective layer further comprises at least one of a binder and inorganic particles.

5. The negative electrode as claimed in claim 4, wherein the binder comprises at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and a combination thereof.

6. The negative electrode as claimed in claim 4, wherein:
the binder is included in an amount greater than 0 wt % to about 20 wt % based on a total amount of the protective layer, and
the inorganic particles comprise at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

7. The negative electrode as claimed in claim 4, wherein the inorganic particles are included in an amount of about 5 wt % to about 70 wt % based on a total amount of the protective layer.

8. The negative electrode as claimed in claim 1, wherein:
the negative electrode active material layer includes a negative electrode active material, and
the negative electrode active material includes at least one of a carbon-based negative electrode active material, a Si-based negative electrode active material, and a combination thereof.

9. A rechargeable lithium battery, comprising:
the negative electrode as claimed in claim 1;
a positive electrode; and
a separator between the negative electrode and the positive electrode.
